(19) United States
(12) Patent Application Publication
(10) Pub. No.: US 2020/0223720 A1
(43) Pub. Date: Jul. 16, 2020

(54) NEW PROCESS FOR THE TREATMENT OF HIGH SULPHATE WATERS

(71) Applicant: SMR TECHNOLOGIES LIMITED, West Midlands (GB)

(72) Inventor: Richard George PAXTON, West Midlands (GB)

(21) Appl. No.: 16/648,947

(22) PCT Filed: Sep. 12, 2018
(86) PCT No.: PCT/IB2018/056966

§ 371 Date: Mar. 19, 2020

(30) Foreign Application Priority Data
Sep. 20, 2017 (NL) 2019581

(51) Int. Cl. C02F 1/52; C02F 1/66; C02F 1/38

(52) U.S. Cl. CPC C02F 1/5245; C02F 2101/101; C02F 1/38; C02F 1/66

(57) ABSTRACT

The present invention relates to an improved process for treating high sulphate waters. In particular, the present invention relates to an improved process making use of aluminium compounds in order to precipitate layered double hydroxide compounds and any one or more of metals, sulphate, aluminate and phosphate. The present invention further relates to the use of one or more particle segregation stages, as well as the return of aluminium containing compounds from the particle segregation stage and aluminium compounds from a further reaction stage to an initial reaction stage.

### FIELD OF APPLICATION OF THE INVENTION

The present invention relates to an improved process for the precipitation of sulphates, phosphates and multivalent metals from high sulphate waters.

### BACKGROUND TO THE INVENTION

Throughout the world, there are many situations where the results of industrial and mining activities create large volumes of waste waters which contain high concentrations of sulphates. Most of these waste waters also contain substantial concentrations of dissolved and colloidally dispersed metals, they frequently have a low pH and they can cause substantial environmental problems unless they are treated appropriately.

There are a large number of technologies available for the treatment of these waste waters and for recovering the water to a quality which is fit for re-use at the site that produced the waste water, for use by others or for safe discharge into the environment. However, all of these technologies come with associated costs. In addition, these technologies create by-products and process residues. These by-products and process residues are derived from the contaminants which have to be removed from the waste water as well as from components within the chemical reagents which have to be used within the particular treatment process that is being applied. Usually, the by-products and the process residues contain components which, from an environmental perspective, are readily leachable. As a result, operating costs tend to be high, both for the necessary reagents and for the safe disposal/recovery of the by-products and the residues.

Most of the currently applied technologies seek to remove the majority of the sulphate content from the waste water in the form of gypsum. Gypsum has a low but significant solubility. This means that following the precipitation of the gypsum there is a residual sulphate concentration within the water. This sulphate concentration is typically between about 3 and 10 times the maximum acceptable concentration for discharge to the local environment or for drinking water purposes.

The normal means that are applied to the waste water in order to create an acceptably low sulphate concentration include ion exchange processes or membrane-based processes, such as reverse osmosis, nanofiltration or a dialysis-based process. These processes have both a high capital cost and a high operating cost. In addition, they frequently suffer from a number of blinding and fouling mechanisms which can result in frequent shut downs for cleaning and to a short operating life for the ion exchange media and/or for the membranes.

An alternative technology is to exploit the very much lower solubility of ettringite and of other calcium alumino-sulphate hydrate compounds. Ettringite and these other calcium alumino-sulphate hydrate compounds have complex crystal structures. These structures are able to include many other ionic components within their crystal lattices, both anions and cations. Ettringite has the generally accepted formula of: Ca₆Al₂(SO₄)₃(OH)₁₂·26H₂O. A common compound within the other calcium alumino-sulphate hydrate compounds is commonly referred to within the cement and concrete industry as mono sulphate. It has the generally accepted formula of: Ca₄Al₂(SO₄)(OH)₁₂·6H₂O. In general, when the crystal growth processes have an adequate supply of calcium, sulphate and aluminate, the reaction kinetics for the creation of ettringite are considerably faster than those for the other forms of calcium alumino-sulphate hydrate compounds.

Ettringite crystals require a high pH and sufficient aluminium, as well as the necessary calcium and sulphate in order for them to grow. As a result of the typically acidic nature and the typically high metals content of the waste waters that are often associated with heavy industry and with mining activities, a substantial quantity of neutralising medium has to be added before ettringite can be created. Lime, because of its relatively low price and general availability, is frequently used to supply this neutralising function. Additionally, this input of lime is normally able to provide the necessary calcium input for an effective ettringite based sulphate removal process.

At a high pH (above the pH of its minimum solubility), aluminium exists in solution predominantly as the hydrated negative ion Al(OH)₄⁻. At low pH (below the pH of its minimum solubility), it exists as a positive ion. The degree of hydration of the positive ion varies from Al³⁺ at low pH through Al(OH)²⁺ to Al(OH)₂⁺ as the pH rises towards the minimum solubility. There are also a number of ionic species which contain more than one aluminium atom per ion and where the OH to Al ratio is also a function of the pH. As the pH is lowered, so the solubility of the various aluminium species increases. Also, as the pH is lowered, the number of hydrogen ions that are used in order to create the higher charge on each aluminium ion will increase. The net result of this behaviour is that in order to form ettringite, four OH⁻ ions are needed per molecule of ettringite, together with two Al(OH)₄⁻ ions, three sulphate ions and six calcium ions. However, when an ettringite molecule is dissolved at low pH, it can release up to twelve hydroxide ions.

Usually, if the sulphate content of the waste water is high enough, gypsum is precipitated within a first stage of the treatment process. Typically, the precipitated gypsum is then removed before the water is routed to a second treatment stage. Within this second treatment stage, a water soluble aluminium reagent is usually added, together with more lime

In most situations the aluminium reagent has a prohibitively high price and/or comes with substantial amounts of associated components. These associated components can add substantially to the issues associated with the process by-products and the process residues. The high reagent cost has led to a number of developments whereby most of the aluminium is recovered from the ettringite product and is re-used within the second treatment stage. Depending on the specifics of the particular aluminium recovery process that is applied, it is usual for a large amount of additional process residue to be created or for large quantities of mono-valent ions to be added to the product water and/or to one or more of the residue streams.

Once the ettringite that has been produced by the treatment process has been removed from the water (usually by a combination of gravity settlement and filtration) the ettringite can be re-dissolved within a lower pH environment. Some of the existing technologies use sulphuric acid, for example, within the SAVMIN Process, to create and maintain this lower pH environment. Others use hydrochloric acid, or a mixture of sulphuric and hydrochloric acid.

With appropriate pH monitoring and process control, the pH can be maintained at a level which is low enough for the ettringite to dissolve but high enough so that the aluminium that is released from the ettringite to be precipitated in the form of amorphous aluminium hydroxide. The calcium and the sulphate portion of the ettringite are normally precipitated in the form of gypsum. The mixture has to be separated into a gypsum product or residue and a sufficiently pure aluminium hydroxide for return to the sulphate removal stage within the overall process. For economic reasons, the gypsum must contain as little aluminium as possible. Similarly, the aluminium hydroxide must contain as little gypsum as is practical.

Within the prior art SAVMIN Process, the slow rates of nucleation and crystallisation of gypsum are exploited. The aluminium hydroxide can be made to precipitate rapidly and providing the resultant precipitate is removed promptly from the reaction mixture, there is relatively little gypsum contamination within the aluminium hydroxide. The gypsum is then crystallised within a subsequent stage, where the kinetics of precipitation are normally assisted by a gypsum seeding process using either fresh or recycled gypsum.

Within another prior art process that has been marketed by Veolia (US 2014/0144843), the addition of hydrochloric acid to the separated ettringite creates a strong solution of calcium chloride. Calcium chloride is an extremely soluble salt and a very high ionic strength solution can be created. Under these conditions it is possible to increase the solubility of gypsum to the extent that with appropriate control over the water content of the mixture, only the aluminium hydroxide is precipitated and the sulphate that is released as the ettringite is dissolved remains in solution, at least until the aluminium hydroxide has been removed from the solution. This process unfortunately creates a concentrated brine residue which requires disposal and/or a substantial amount of chloride ions are added to the treated waste water.

An alternative approach is to utilise a substantially lower pH for the dissolution of the ettringite. With this approach, the aluminium remains in solution and the gypsum can be crystallised and separated as a high purity product by simple gravity separation, by filtration or by other appropriate means. One down side of this option is the cost of the extra acid to carry out this dissolution. Additionally, extra lime is needed within the further reaction stage in order to raise the pH of the recovered aluminium solution to the high pH that is needed for ettringite formation. Further, if hydrochloric acid or another monovalent acid is used for this pH reduction, a concentrated brine is created, and/or a high concentration of chloride or other monovalent anion is introduced into the product water.

Unfortunately, the reagent costs associated with these aluminium recovery options have meant that the currently practiced ettringite-based processes represent an expensive method for reducing the sulphate concentration.

Another method for reducing the high operating costs associated with the necessary aluminate input to the formation of ettringite is to create a fresh source of sodium aluminate at or adjacent to the treatment process for the high sulphate content waste water. Such a process is described within WO 2015/128541. Here a source of aluminium hydroxide or hydrated aluminium oxide (usually in the form of gibbsite or bayerite) is reacted with a strong caustic soda (NaOH) solution at temperatures preferably in excess of 90° C. to form a concentrated solution of sodium aluminate. This solution is then used within the ettringite production process. The advantages that are claimed for the reagent that is produced within this process relative to purchased sodium aluminate solution are the somewhat lower cost of the reagent per unit of aluminate and the greater availability of that aluminate to the formation of ettringite within the ettringite production process. Unfortunately, this process causes a substantial concentration of sodium to be added to the treated water that is created by the process.

Providing the ionic strength of the solution is not too high, gypsum precipitation is normally able to achieve a sulphate concentration in the order of 1300 to 2000 mg/litre. This is considerably above the 100 to 250 mg/litre of sulphate that is required for many of the options for either the re-use or the discharge of the treated water. This, combined with the high operating costs of the currently practiced ettringite based processes, have led to a general preference by many water treatment specialists for the use of membrane-based approaches rather than ettringite for this sulphate reduction step.

For most industrial or mining derived waste waters, iron is frequently present in large quantities. When Fe(III) ions are precipitated as a hydroxide or a hydrated oxide, they are very effective at co-precipitating both dissolved and colloidal compounds, both inorganic and organic.

Ettringite has a substantial capability for retaining a similar range of contaminants within its particle structures and also on its particle surfaces. Additionally; other calcium alumino-sulphate hydrate compounds have similar capabilities, but normally to a lesser extent. As a result, these contaminants can be substantially depleted within the treated aqueous phase that is created within the reaction stage where the ettringite and the other calcium alumino-sulphate hydrate compounds are created.

Layered double hydroxide compounds are known to be particularly good at retaining contaminants both within their particle structures and also on their particle surfaces. The contaminants that they are able to retain include metals, phosphates (both inorganic and organic), silicates, most of the other potentially undesirable multi-valent inorganic contaminants and many of the potentially undesirable organic contaminants that could be present within the waste water or within any of the other components that may be added to a treatment process.

Layered double hydroxide compounds are known to be precipitated generally within the pH range of pH 7 to pH 11, i.e. within the pH range that leads all of the way up to the onset of ettringite precipitation.

There are three principal forms of hydrated calcium aluminate, which (using cement technology notation) have the formula CAH₁₀, C₂AH₈ and C₃AH₆. CAH₁₀ and C₂AH₈ are the metastable forms and C₃AH₆ is the thermodynamically stable form and also the least soluble form. However, at temperatures below about 50° C., the other two forms are created almost exclusively. Once these metastable forms have been created, they are slowly converted into the thermodynamically stable form. This conversion is very slow at ambient temperatures.

The relative proportions of the CAH₁₀ and the C₂AH₈ forms that are created when hydrated calcium aluminate is precipitated are a function of both the temperature and the available reaction time. Below about 15° C., the CAH₁₀ is created almost exclusively. Between about 15° C. and 27° C., both forms can co-exist and above about 27° C., the C₂AH₈ form tends to predominate. Subject to the availability of both Ca and OH within the reaction mixture, CAH₁₀ slowly converts into C₂AH₈ and, very much more slowly, the C₂AH₈ converts into C₃AH₆. The rate of conversion increases with increasing temperature. It is anticipated that increasing levels of pH will favour an increasing proportion of C₂AH₈ relative to CAH₁₀. The hydrates begin to form at a pH of about pH 8 and their rate of formation increases rapidly with increasing pH.

The generally accepted chemical formula for CAH₁₀ is Ca(Al(OH)₄)₂·6H₂O.

The generally accepted chemical formula for C₂AH₈ is Ca₂(Al(OH)₄)₂(OH)₂·3H₂O.

In order to create CAH₁₀, two additional hydroxide ions and an additional calcium ion have to be added to two aluminium hydroxide molecules. In order to create C₂AH₈, four additional hydroxide ions and two additional calcium ions have to be added to two aluminium hydroxide molecules

### OBJECT OF THE INVENTION

Accordingly, it is an object of the present invention to provide a process for the improved treatment of high-sulphate waters using a combination of chemical and physical methods which address the shortcomings associated with the prior art and the currently employed technologies.

### SUMMARY OF THE INVENTION

According to a first aspect thereof, the present invention provides a process for the treatment of sulphate-containing water, the process including:
an initial reaction stage for receiving a feed water derived from sulphate-containing water and other inputs, a further reaction stage, a first particle segregation stage, and a second particle segregation stage;
the initial reaction stage creating an initial reaction mixture comprising suspended particles suspended within a partially treated aqueous phase;
the first and second particle segregation stages comprising assemblies of one or more devices using differences between particle settling velocities of the suspended particles within the partially treated aqueous phase to segregate such suspended particles into a first group of particles and a second group of particles;
the first group of particles having a similar or lower settling velocity within the partially treated aqueous phase relative to the average settling velocity within the partially treated aqueous phase of particles of aluminium containing compounds that are precipitated within the initial reaction stage;
the first group of particles in admixture with a first portion of the partially treated aqueous phase being forwarded to an overhead product;
the second group of particles having a higher average particle settling velocity within the partially treated aqueous phase relative to the average settling velocity within the partially treated aqueous phase of particles of aluminium containing compounds that are precipitated within the initial reaction stage;
the second group of particles in admixture with a second portion of the partially treated aqueous phase being forwarded to an underflow product;
the first particle segregation stage being used to create a first overhead product from the initial reaction mixture;
the first overhead product being forwarded to the further reaction stage;
the further reaction stage producing aluminium compounds selected from the group comprising calcium alumino-sulphate hydrate compounds;
the initial reaction stage being operated at a pH that is greater than pH 7 and less than that which is necessary for the formation of ettringite;
the suspended particles comprising particles precipitated within the initial reaction stage and other particles included within the feed water and within other inputs to the initial reaction stage;
the initial reaction mixture further containing dissolved and precipitated aluminium containing compounds;
the underflow product from the first particle segregation stage being returned to the initial reaction stage;
compounds selected from the group comprising aluminium containing compounds, calcium containing compounds, and hydroxide containing compounds being added to the further reaction stage;
aluminium compounds from the further reaction stage, being returned to the initial reaction stage;
the second particle segregation stage producing a second overhead product from the initial reaction mixture, the second overhead product being returned to the initial reaction stage;
the second particle segregation stage producing a second underflow product from the initial reaction mixture, a portion or all of the second underflow product being a process residue; and
aluminium compounds from the further reaction stage being used within the initial reaction stage to precipitate layered double hydroxide compounds, hydrated hydroxide-based compounds and any one or more compounds containing metals, sulphate and/or phosphate.
   wherein adjunct reagents, including compounds selected from the group comprising dolomite, limestone, dolomitic lime, lime, other hydroxide containing compounds, sulphuric acid and other acidic compounds, in any combination, are optionally added to the initial reaction stage.

In an embodiment, the aluminium compounds from the further reaction stage may include calcium alumino-sulphate hydrate compounds.

In an embodiment, the process may include adjunct reagents including compounds selected from the group comprising dolomite, limestone, dolomitic lime, lime, other hydroxide-containing materials, sulphuric acid and other acidic compounds, in any combination.

In many situations, a combination of low pH and a high concentration of dissolved metals within the feed water will enable all of the ettringite and of all of the calcium alumino-sulphate hydrate compounds that are created within the further reaction stage to be dissolved within the initial reaction stage before the pH has been raised to just below that at which ettringite begins to precipitate. An additional hydroxide containing material may also be required in order to raise the pH to just short of the pH at which ettringite will begin to precipitate.

The complete utilisation of the ettringite and of all of the calcium alumino-sulphate hydrate compounds means that within the residues from the process, all of the contaminants that are removed by co-precipitation and sorption processes will be associated with either Fe(III) based co-precipitation or with layered double hydroxides. They will therefore not be leachable to any significant extent within a typical waste depository for all pH>pH 7, whereas if they were retained by ettringite or by other calcium alumino-sulphate hydrate compounds, a minimum pH of >pH 10 would be necessary for a similar degree of leaching resistance.

In an embodiment, the devices that are used within the particle segregation stages may include technologies selected from the group comprising hydrocyclones, centrifuges, gravity separation and screw classification.

The present invention exploits the capabilities of hydrocyclone technology and/or other particle segregation technologies to avoid the need for a clarification stage upstream of the further reaction stage and to include within the partially treated water stream that is forwarded into the further reaction stage aluminium that is liberated from the ettringite, from the other calcium alumino-sulphate hydrate compounds and from any other sources of aluminium that are added to the reaction stages. Additionally, the use of hydrocyclones and/or other particle segregation technologies allows the present invention to recover seed crystals for all of the species of compounds that are precipitated within the stages preceding the particle segregation stage. Hydrocyclones and/or other particle segregation technologies also allow control of the relative proportions, particles sizes and particle size distributions of the seed crystals so as to optimise the average size and size distribution of the species that are precipitated.

In a further embodiment, at least one of the particle segregation stages may include a washing process and/or leaching process.

As noted above, a feature of the present invention is that the partially treated water from the initial reaction stage does not need to be clarified before it is forwarded to the further reaction stage. Instead, all that is needed is to separate and recycle the appropriate sizes and quantities of seed crystals from the mixture of suspended solids that are produced within the initial reaction stage, and to include within a hydrocyclone overhead product (or the equivalent product from a suitable and alternative device) the required volume of partially treated water and the optimum proportion of Available Aluminium relative to unwanted gypsum and to forward that product to the further reaction stage. The term ‘Available Aluminium’ refers to all of the various forms of aluminium that would be dissolved and/or precipitated within the initial reaction stage other than the aluminium that would be within the layered double hydroxide compounds and within any C₃AH₆ that might be produced.

In the process of the present invention, the overall quantity of layered double hydroxides and other hydroxides that is allowed to accompany this product into the further reaction stage is relatively immaterial. Within the further reaction stage these hydroxide compounds are virtually unaffected and they are returned within the product slurry from the further reaction stage to the initial reaction stage. All that is needed is to ensure that sufficient of these precipitated solids are removed from this recycle loop so as to prevent the circulating slurry from accumulating a concentration of suspended solids that could affect the desired performance of the hydrocyclones or the suitable and alternative devices.

It is also possible to utilise hydrocyclones or suitable and alternative devices to separate and remove from the reaction mixture the necessary amounts of both gypsum and the other precipitation products and to route them to a product recovery facility, recycle facility or suitable discard facility, whilst at the same time incorporating with the materials that are removed as little as is practical of the Available Aluminium.

In an embodiment of the invention, the process may further include a first particle removal stage following the further reaction stage. In a preferred embodiment, the pH of a particle depleted water that is created within this first particle removal stage may be reduced by a neutralising agent within a further neutralisation stage to produce a neutralised water and precipitated solids, the precipitated solids being created within the neutralisation stage and separated within a second particle removal stage. In a further preferred embodiment, a portion of the precipitated solids created within the neutralisation stage may be returned to an earlier stage in the process. In a yet further preferred embodiment, a portion of the precipitated solids created within the neutralisation stage may be returned to the further reaction stage. The neutralising agent used within the neutralisation stage may be selected from the group comprising, carbon dioxide, bicarbonate and carbonate containing compounds.

In an embodiment, the sulphate-containing waste water may be a mine waste water.

According to a second aspect thereof, the present invention provides a purified water product produced by the process as described herein above.

### Advantages

An advantage of the present invention is economical in that the reuse of reactor products, in the form of amorphous Al(OH)₃, hydrated aluminium oxide, aluminate ions, hydrated calcium aluminate compounds, ettringite, other calcium alumino-sulphate hydrate compounds, precipitated ferric ions and gypsum is expected to substantially lower both the operating costs and the ground area requirements for facilities employing ettringite based technologies to treat sulphate-rich water.

As a result of the creation of the layered double hydroxide compounds, the present invention is able to exploit the extensive capability of these compounds to retain contaminants both within their particle structures and also on their particle surfaces. The contaminants that they are able to retain include metals, phosphates (both inorganic and organic), silicates, most of the other potentially undesirable multi-valent inorganic contaminants and many of the potentially undesirable organic contaminants that could be present within the waste water or within any of the other components that are added to the process.

A further advantage of this invention is the formation within the initial reaction stage of a mixture of the various metastable forms of hydrated calcium aluminate. With appropriate process control, especially in relation to the control of the pH regime within the initial reaction stage, all, or virtually all of the aluminium hydroxide that is precipitated as a result of the dissolution of the ettringite and of the other calcium alumino-sulphate hydrate compounds and which has not been used within the formation of the layered double hydroxide compounds, can be dissolved and re-precipitated within this mixture as a mixture of the many metastable forms of hydrated calcium aluminate. This re-precipitation requires a considerable addition of hydroxide; hydroxide which can come from the ettringite, from the other calcium alumino-sulphate hydrate compounds and, when needed, from an appropriate addition of a hydroxide containing reagent.

Another advantage of the present invention, from the perspective of safe residues disposal, is the low solubility of the types of layered double hydroxides that are likely to be precipitated within the above described reactions. This low solubility occurs throughout the approximate pH range of pH 7 to 13, whereas the equivalent low solubility range for ettringite and for the other calcium alumino-sulphate hydrate compounds is restricted to the approximate pH range of pH 10 to 13. This means that within a disposal facility the contaminants that are removed from the reaction stages within the layered double hydroxide compounds will have a much lower leachability than they would if their leachability relied on the stabilities of ettringite and of other calcium alumino-sulphate hydrate compounds.

Additionally, the present invention would remove the need for easily-fouled membrane-based and/or ion exchange and/or other resin based systems for the treatment of sulphate-rich water.

Finally; the present invention is able to achieve contaminant removal efficiencies which exceed those which can be achieved currently within a single stage RO process.

### BRIEF DESCRIPTION OF THE DRAWINGS

The invention will now be described in more detail, by way of example only, with reference to the accompanying FIGURE in which:

FIG. 1 shows a diagram illustrating a preferred embodiment of the process of the present invention.

The foregoing and other objects, features and advantages of the present invention will become more apparent from the following description of certain embodiments of the present invention by way of the following non-limiting example.

### DETAILED DESCRIPTION OF THE INVENTION

The following represents a non-limiting example of preferred embodiments of the invention.

### Preamble

The present invention relates to a process for the recycling of the aluminium content of both the ettringite and the other calcium alumino-sulphate hydrate compounds. As such, this recycling method does not normally require the use of an acid addition step when processing water which is typically acidic and high strength, such as ARD (acid rock drainage) from an active or former mining activity. Instead, the process typically uses the acidic nature of the waste water (or feed water), along with the dissolved multi-valent metal content of the water that is being treated, to dissolve the ettringite and the other calcium alumino-sulphate hydrate compounds and thereby to precipitate gypsum, to precipitate most of the multi-valent metals and to create a range of hydrated aluminium containing compounds. This use of the acidity within the incoming waste water can eliminate the need for acid addition in order to recover the aluminium.

In addition; within the initial reaction stage which precedes the further reaction stage that is responsible for the production of the ettringite and the other calcium alumino-sulphate hydrate compounds, the present invention uses a portion of the aluminium content of the ettringite and of the other calcium alumino-sulphate hydrate compounds, together with any aluminium and magnesium that are present within the feed water or within any of the other components that are added to the process, in order to create layered double hydroxide compounds and a mixture of many of the metastable forms of hydrated calcium aluminate.

### Initial Reaction Stage

In the initial reaction stage, high sulphate water enters into an initial reaction stage, where a source of ettringite and/or other calcium alumino-sulphate hydrate compounds are used; with the optional addition of materials selected from the group including, but not limited to limestone, dolomite, lime, dolomitic lime, calcium-containing materials and hydroxide-containing materials (‘modification agents’). These additions may be used to raise the pH of the reaction mixture to a value which is just less than the pH at which Ettringite would begin to form. This pH is temperature specific and is also affected by the ratio of calcium ions to sulphate ions within the aqueous phase. At 25° C. a typical pH for the end of the initial reaction stage would be between pH 10.5 and pH 11.0. At lower temperatures, this pH range would be a little lower. This raising of the pH causes other components; including gypsum, amorphous aluminium hydroxide, other metal hydroxides, layered double hydroxide compounds and hydrated calcium aluminate compounds; to also precipitate.

Whenever there is sufficient or more than sufficient ettringite available to create the above referred pH, there will be no need to add additional pH-raising materials and the optimum pH will be achieved automatically. Otherwise; controlled addition of modification agents will be required. The principal criteria for determining the quantity of each controlled addition will be the measured pH value, the measured magnesium concentration relative to the desired magnesium concentration and the measured concentrations of the relevant contaminants relative to their desired concentration limits.

For situations where the neutralising capability of the high sulphate water is insufficient to ensure that all, or almost all of the ettringite and other calcium alumino-sulphate hydrate compounds are dissolved within the initial reaction stage, it is appropriate to add a suitable acidic compound to the initial reaction stage so as to ensure that all, or almost all of the aluminium content of the ettringite and other calcium alumino-sulphate hydrate compounds is made available for creating the necessary amount of layered double hydroxide compounds and for the economic recovery of aluminium to the further reaction stage. In these situations and depending upon the available sources of aluminium, it may be more economic to include suitable acidic compound(s), such as sulphuric acid, within the modification agents, that may be added to the initial reaction stage to assist the maximum recovery of aluminium to the further reaction stage than it is to add the otherwise necessary additional amounts of aluminium-containing reagents to the further reaction stage. Here, the complete utilisation of the ettringite and of all of the calcium alumino-sulphate hydrate compounds means that the leachability of any environmentally sensitive components from the solid residues from the process will be minimised.

Once the precipitation processes have mostly stabilised (e.g. once the reaction mixture has reached the last chamber within a multi-chamber initial reaction stage), the majority of the aluminium containing hydroxide particles and the hydrated calcium aluminate particles, together with, typically, the majority of the aqueous phase, is segregated within a first particle segregation device from the remainder of the process mixture. The segregated particles and aqueous phase are routed to a further reaction stage. The remaining aqueous fraction and the remaining suspended particles are returned to the initial reaction stage. The portion of the aqueous fraction that is forwarded to the further reaction stage may be sized and controlled so as to maintain, on average, a constant volume of reaction mixture within the initial reaction stage.

A second particle segregation device may also be used to segregate and remove particles that have a higher settling velocity than the majority of the aluminium containing hydroxide particles and the hydrated calcium aluminate particles that are within the mixture of particles that develops within the initial reaction stage and to return to the initial reaction stage all of the particles that are not so segregated and removed. In relation to those particles that are returned to the initial reaction stage, ongoing precipitation onto the returned particles will increase their particle size.

The particles that are removed within the second particle segregation device are then dewatered or otherwise processed to form a process discard and any water and fine solids that are separated from the removed particles are returned to the initial reaction stage. Here, hydrocyclone-based technology is used for the second particle segregation device; with screw classification technologies, gravity-based clarification technologies, and centrifuge-based technologies being optionally included for these particle segregation and removal processes.

Where further process refinements are needed, a portion of the particles with a higher settling velocity that are segregated and removed from the reaction mixture within the second particle segregation will be further purified using techniques that would be well known by skilled practitioners and the components separated from the larger particles returned to the initial reaction stage. Here hydrocyclone-based washing and leaching, preferably using some or all of the high sulphate feed water as a washing and leaching fluid, may be used as a purifying technique.

Magnesium is a major component within most of the layered double hydroxide compounds that are likely to be produced within the process. Appropriate selection of both the composition and the quantity of the additions to the process can therefore be used both to ensure sufficient removal of contaminants upstream of the further reaction stage and, if necessary, to lower the dissolved magnesium concentration to the desired concentration within the final product water. Normally there is sufficient magnesium within most high sulphate waters to ensure that a sufficient amount of layered double hydroxide compounds are created in order to achieve adequate removal of the trace contaminants. If needed, additional magnesium inputs can be achieved by adjusting the ratio between the dolomitic lime and the ordinary lime that is added. Alternatively, a suitable magnesium based reagent such as magnesium sulphate could be used. All of these adjustments are determined and controlled on the basis of both pH determinations and chemical analysis.

Whenever there is sufficient or more than sufficient ettringite and/or other calcium alumino-sulphate hydrate compounds available to create the above referred pH, there will be no need to add modification agents, as the optimum pH will be achieved automatically. Under these circumstances, should additional magnesium be required in order to create a sufficient quantity of layered double hydroxides, then the magnesium would need to be added as a magnesium salt such as magnesium sulphate rather than as dolomitic lime or magnesium hydroxide.

The size of acid additions, if necessary, are determined and controlled on the basis of pH determinations and chemical analysis. For example, a sample of the reaction mixture from within the later stages of the initial reaction stage can be taken and whilst it is being stirred continuously, it can be subjected to the controlled addition of an acidic reagent. If the pH begins to fall immediately, then all or virtually all of the ettringite and the other calcium alumino-sulphate hydrate compounds will have already been dissolved. If the pH does not begin to fall until a significant amount of acidic reagent has been added, then a significant amount of the ettringite and the other calcium alumino-sulphate hydrate compounds will not have been dissolved by that stage within the initial reaction stage. The size of the controlled addition to the stirred sample prior to the pH beginning to fall can be used to guide the determination of the additional requirement of acidic reagent to the initial reaction stage. In all cases, a repeat of the sampling and testing procedure should be used to confirm that sufficient of the ettringite and the other calcium alumino-sulphate hydrate compounds have been dissolved.

### Further Reaction Stage

The further reaction stage is used to precipitate ettringite and other calcium alumino-sulphate hydrate compounds from partially treated high sulphate water. In this stage, slaked lime, burnt lime or another suitable hydroxide reagent is added to the mixture of aluminium hydroxide, hydrated calcium aluminate compounds and the aqueous fraction that is segregated and forwarded from the first particle segregation device(s). In addition, if necessary, an additional aluminium containing reagent is added to the partially treated high sulphate water. Preferably, the aluminium reagent would not include any unwanted monovalent ions within its formulation. The quantities of the added materials and the ratios between the quantities of each material are determined and controlled on the basis of both pH determinations and chemical analysis. The objective is to encourage the formation of ettringite within the reactor whilst avoiding the creation of other calcium compounds or other impurities and whilst achieving the desired removal of sulphate and calcium from the water.

Preferably, the reaction stage will consist of a multi-compartment reactor, the reactor including suitable stirring and/or alternative mixing arrangements within each compartment. In a further embodiment, the compartments would be arranged in series. A sludge recycle is preferably included within one or more of the reaction stages so as to assist the optimisation of the availability of appropriately sized seed crystals to the precipitation processes and thereby to assist the achievement of the optimal performance from the particle segregation devices.

pH and analytically based control is used for the control of calcium, sulphate and aluminium concentrations within each reaction stage so that within the further reaction stage the relative proportions of these components are kept substantially stoichiometric with respect to the quantities of calcium and sulphate that are desired to be removed. Normally; the proportion of aluminium that enters the further reaction stage is controlled such that it is the first of these components to be depleted. The calcium to sulphate ratio is also controlled by adjusting the relative proportions of calcium oxide, calcium hydroxide and other hydroxide reagents that are added to one or more of the reaction stages.

The product slurry from the further reaction stage contains a mixture of ettringite crystals, calcium alumino-sulphate hydrate crystals and other precipitates. These precipitates may include metal hydroxides, hydrated metal oxides, layered double hydroxides, silicates, carbonates and any other trace compounds that may be present. These precipitates would not, however, contain significant quantities of gypsum. Typically, the ability of ettringite crystals and calcium alumino-sulphate hydrate crystals to incorporate within themselves both anions and cations, especially the multivalent ones, will result in the dissolved concentrations of usually all of the multivalent anions and cations (except sulphate and calcium) being substantially below their normally expected solubility limits within the aqueous phase of the product liquor from the further reaction stage.

The product from the further reaction stage consists of a slurry which has a high pH and the desired concentration of sulphate and calcium. The sludge pH is normally between pH 10.5 and pH 12.0. The precipitated solids are separated from the treated water within a first clarification stage using a suitable solids separation and clarification process, as known and described in the art so as to create a first clarified water. Preferably, all of the precipitated solids from the further reaction stage are added to the initial reaction stage.

The first clarified water is then treated within a neutralisation stage using a pH reducing agent(s) so as to produce neutralised water with a reduced pH and so as to precipitate amorphous aluminium hydroxide. The pH reducing agent(s) would preferably include carbon dioxide, bicarbonate compounds, carbonate compounds or combinations thereof; for the additional purpose of precipitating calcium carbonate. Preferably, the pH of the neutralised water, once treated, would be between pH 6.0 and pH 9.5. A second separation stage, as known in the art, would be used to remove residual aluminium hydroxide particulates and other particulates that may be produced by the pH adjustment of the first clarified water. The pH of the final product may be adjusted again using techniques known in the art, to a pH within the range of pH 6.0 to pH 7.5, with an additional solids removal stage to remove precipitated solids following the final pH adjustment.

### Example 1 New Process for Treatment of Sulphate-Rich Waters

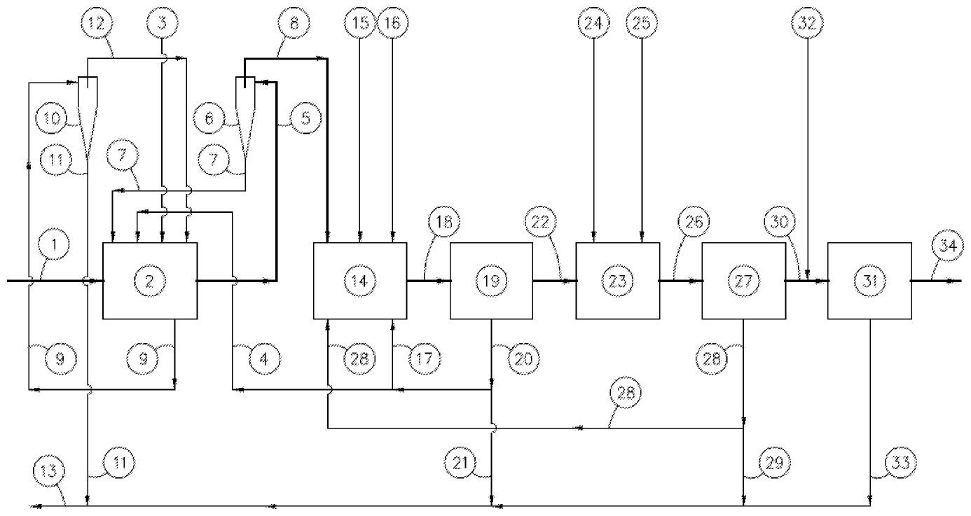

With reference to FIG. 1, high sulphate water enters as stream 1 into the initial reaction stage 2. Also entering the initial reaction stage is the input of lime or a suitable hydroxide containing material 3 and a recycle stream 4 of ettringite and other calcium alumino-sulphate hydrate compounds from a first clarification stage 19 that follows the further reaction stage 14. Stream 5 delivers reaction mixture from the initial reaction stage 2 and/or from the output stream 12 from the second particle segregation device 10 into the first particle segregation device 6.

Both of the particle segregation devices 6 and 10 are shown as utilising hydrocyclone technology. Typically, depending upon the volumetric flow rate within stream 1, an assembly of hydrocyclones arranged in parallel would be used for each of these particle segregation duties; although for simplicity only one is shown for each duty.

Alternative particle segregation devices such as gravity separation units, elutriation units, centrifugal devices, screw classifiers and other devices that are known to skilled practitioners could also be used instead of or in conjunction with hydrocyclone based devices.

The majority of both the aluminium hydroxide particles and the hydrated calcium aluminate particles within stream 5 are segregated within the first particle segregation device 6 from the majority of the remainder of the particles within stream 5 and, together with a portion of the aqueous phase the segregated particles are routed to the further reaction stage 14 via stream 8. The size of the first particle segregation device 6 and the volumetric flow within stream 5 is sized so that the volumetric flow within stream 8 is able to maintain the overall volumetric balance within the initial reaction stage 2. The primary design requirement for the first particle segregation device would be for it to segregate into the output stream 7 those particles which have a larger settling velocity than the average settling velocity of the aluminium hydroxide particles, the hydrated aluminium containing compounds and the hydrated calcium aluminate particles that are present within stream 5 and to include within stream 8 as few as possible of those particles which have a higher settling velocity than the average settling velocity of the aluminium hydroxide particles, the hydrated aluminium containing compounds and the hydrated calcium aluminate particles.

The output stream 7 from the first particle segregation device is returned to the initial reaction stage 2. Stream 8 is therefore the product stream from the initial reaction stage 2.

Stream 9 feeds reaction mixture from the initial reaction stage 2 into the second particle segregation device 10. This device is also shown in this example embodiment as utilising hydrocyclone technology. Typically, depending upon the volumetric flow rate within stream 9, an assembly of hydrocyclones arranged in parallel would be used, although for simplicity only one is shown. The role of the second particle segregation device 10 differs from the first particle segregation device in that its primary design requirement would be for it to remove into a concentrated underflow 11 those particles which have a significantly larger settling velocity than the average settling velocity of the aluminium hydroxide particles, the hydrated aluminium containing compounds and the hydrated calcium aluminate particles that are present within the feed stream 9 and to include within stream 11 as little as possible of the Available Aluminium content of stream 9. It should be noted that at the preferred pH conditions that should exist within the initial reaction stage, aluminium has a significant solubility within the aqueous fraction of the reaction mixture. Stream 12 is therefore able to recover dissolved aluminium, aluminium hydroxide, hydrated aluminium containing compounds and hydrated calcium aluminate back into the initial reaction stage thereby minimising the amount of aluminium that is lost from the process within stream 11.

The optimal location within the initial reaction stage 2 for the return of streams 7 and 12 will depend upon the reactor style and the arrangement that is selected for the reaction stage. However, assuming that a multi stage-reactor is selected, with the stages arranged in series, stream 12 should preferably be returned to the same stage as the offtake for stream 5 is located and stream 7 should be returned to the same stage as where stream 1 enters.

The magnitude of stream 9, the detailed mechanical arrangements for the return of stream 12 and the offtake arrangements for stream 5 should be such that stream 5 is made up almost entirely or preferably entirely from the contents of stream 12. There are numerous ways that will be well known to skilled practitioners for achieving this preferred arrangement which, irrespective of a flow disturbance within stream 12, will ensure the continuity of flow within stream 5 and which will not prejudice the level control arrangements that will be needed within the initial reaction stage 2.

Preferably, a portion of stream 4 should also enter the same stage as where stream 1 enters. The remainder should then be delivered to subsequent stages. The amount that is delivered to each stage should be controlled by suitable control valves or other appropriate devices with the control of those devices being determined based upon the measured pH within the respective stage of a multi-stage initial reaction stage.

Any modification agents that are required in order to achieve the optimal pH within the output stream 8 from the initial reaction stage will enter at stream 3. Once all of stream 4 has been utilised, the input of stream 3 is used to maintain the set point pH within the remaining stages of the initial reaction stage. For those situations where an acidic input to the initial reaction stage is required, this would be added at an adjacent position to stream 3. Clearly, when an acidic input into the initial reaction stage is required, there will not normally be a simultaneous requirement for a hydroxide containing addition. However, for those situations where there is a potential for substantial variations within the nature of the feed water 1, facilities for the addition of both types of reagent should preferably be provided.

The amount of stream(s) 3 material that would be delivered to each stage is controlled by suitable control valves or other appropriate devices with the control of those devices being determined based upon the measured pH within the respective stage.

Stream 11 is routed to the solids discard 13. The solids discard arrangement can utilise whatever facilities and technology that may be appropriate to the location and nature of the water treatment facility. For convenience, but only for convenience, the solids discard is shown here as a single facility that receives a combined stream that is made up from the different residue streams 11 and 33 and the optional residue streams 21 and 29. However, one or more of these residue streams could be routed separately or in any combination to one or more alternative facilities, as may be appropriate to the contents of the residue stream and to the location and nature of the water treatment facility.

As noted above, stream 8 is the product stream from the initial reaction stage 2 and it is routed to the further reaction stage 14. The further reaction stage 14 also receives an additional input of lime and/or a calcium and/or hydroxide containing material 15 and, if appropriate, a portion 17 of the solids output 20 from the first clarification stage 19 that follows the further reaction stage 14.

A portion 17 of the solids output is returned to the reaction stage 14 if the reactor design for this reaction stage is unable to maintain a sufficient quantity of seed crystals within the reactor for optimum reaction conditions.

Depending upon the aluminium and the sulphate content of the process feed water stream 1, the aluminium content of the various reagents that are added to the process, the efficiency of the particle segregation stages 6 and 10 and the amount of aluminium hydroxide that is present within the sludge stream 28, it may be necessary to add a source of aluminium hydroxide or some other form of Available Aluminium 16 into the further reaction stage 14.

The further reaction stage 14 preferably consists of a multi-stage reactor with the stages arranged in series, with streams 8 and 28 entering the first stage within the further reaction stage. The amount of stream 15 material that is delivered to each stage is controlled by suitable control valves or other appropriate devices, with the control of those devices being determined based upon the measured pH within the respective stage.

The amount of stream 16 material that is delivered to each stage is controlled by suitable control valves or other appropriate devices with, the control of those devices being determined based upon the measured aluminium concentration within the respective stage. However, the on-line determination of the concentration of the Al(OH)₄⁻ ions is not straight forward within the conditions that will prevail within the further reaction stage. It is therefore easier to determine the concentration of the Al(OH)₄⁻ ions preferably within the output stream 18 from the reactor and to then distribute the input of stream 16 in proportion to the amount of aluminium that, on average, is being used within the respective stages within the further reaction stage.

The concentration of Al(OH)₄⁻ ions can be determined for each stage within a multi-stage reactor by simultaneously extracting and filtering a sample from the respective stage, reducing the pH of the filtrate to a pH of less than 3.0 (so as to convert all of the Al(OH)₄⁻ ions to positive ions) and determining the aluminium concentration using one of the standard procedures that are well known to a skilled practitioner. The determination of the concentration of the Al(OH)₄⁻ ions within each stage of the multi stage reactor will enable a skilled practitioner to select the relative proportions of any aluminium inputs that may need to be added to each stage within a multi-stage reactor.

The amount of aluminium that will be used within each stage of the further reaction stage will be approximately proportional to the amount of lime that is used within that stage. For simplicity therefore, but not shown here, it is convenient to add stream 16 to stream 15 upstream of the control arrangements that will be controlling the amount of stream 15 that is delivered to each stage within the further reaction stage. The amount of stream 16 that is added to stream 15 is controlled by a suitable control valve or another appropriate device with the control of that device being determined based upon the measured Al(OH)₄⁻ ion concentration within stream 18.

The reacted product 18 from the further reaction stage 14 is routed to the first clarification stage 19. As noted above, some of the separated suspended solids 20 from the first clarification stage 19 may be returned (stream 17) to the further reaction stage 14 as a source of seed crystals. Normally, the whole of the remainder, stream 4, or all of the separated solids 20 would be routed to the initial reaction stage 2. Preferably, but not shown here, the water content of stream 4 is reduced as much as is practical, consistent with maintaining a continuous feed of stream 4 contents into the initial reaction stage. The water that is separated from stream 4 will typically contain a significant proportion of fine particles and these can be preferentially used as seed crystals within the further reaction stage. Alternatively, the water that is separated from stream 4 can be added to stream 18.

In some situations there may be more ettringite and/or other calcium alumino-sulphate hydrate compounds produced within the process than is needed within the initial reaction stage 2. The excess can still be beneficially included within stream 4 where its calcium carbonate content can be beneficial. Alternatively, the excess can be discharged as indicated by stream 21 to the discard facility 13, to an alternative discharge facility (not shown here) or it can be stored within a suitable buffer storage facility (also not shown here) for use, for example, during a process re-start.

The first clarified water 22 from the first clarification stage 19 is then passed to a neutralisation stage 23 where a calcium precipitating reagent 24 such as carbon dioxide, a bicarbonate or carbonate compound or some other appropriate reagent may be added in order to reduce the calcium concentration within the clarified water 22 and, depending on the reagent that is used, to reduce the pH of the clarified water. Alternatively, or in addition, in order to achieve the desired final pH and to ensure sufficient precipitation of the aluminium content of the clarified water 22, a controlled amount of a pH adjusting acidic reagent 25 would also be added. The reagent 24 may consist of a number of different reagents which are added as a blended mixture, individually or in partial combination. Similarly, the acidic reagent 25 may consist of a number of different reagents which are added as a blended mixture, individually or in partial combination.

The product 26 from the neutralisation stage 23 is then routed to a second clarification stage 27 where the residues from the neutralisation reactions, including aluminium hydroxide from any unreacted aluminium, are removed. The separated solids 28 from this second clarification stage 27 are normally routed to the further reaction stage 14 via stream 28. This residue stream usually contains a significant proportion of aluminium hydroxide as well as often containing precipitated calcium carbonate. It is therefore appropriate to route these residues back to the further reaction stage so as to utilise the aluminium content within this reactor. The calcium carbonate content of this stream would be unaffected within the further reaction stage and, within a preferred arrangement it would all join the stream 4 for addition into the initial reaction stage, rather than for some of it to be discharged via stream 21 to the discharge facility 13.

Alternatively, but not shown here, a portion or all of stream 28 is routed directly to the initial reaction stage 2.

After the neutralisation stage 27, it is often necessary to carry out a further polishing type of process (step 31) to the clarified output 30. In addition, it is sometimes necessary to add further components in order to satisfy any particular requirements that may be imposed by the discharge or re-use criteria. Any such further additions are shown as one or more inputs 32.

Within many of the discharges from industry or from mining activities, the dissolved nitrogen content may be too high for the proposed re-use or discharge criteria. This nitrogen can be present as both inorganic nitrogen containing compounds, organic nitrogen containing compounds or as a mixture of both. Other organic compounds could also be present, including phosphorous containing compounds. There are a number of well-known technologies for removing these contaminants and the selection of the appropriate technology or technologies is dictated by the specific nature and quantities of the contaminants, the local circumstances, costs and operator preferences. Location 31 is the typical position within the above described overall treatment process where these nitrogen and other contaminating compounds would normally be removed. Any solid, sludge or other residues 33 from this location will normally join the overall residue discard 13, as shown. However, depending upon what has to be removed, it may be appropriate to route them, or some of them, to another process outlet.

The finally treated water 34 would then be available for re-use or for discharge.

1. A process for the treatment of high sulphate water, the process including:
an initial gypsum precipitation stage that receives high sulphate feed water, an ettringite production stage, a first particle segregation stage a second particle segregation stage and a first particle removal stage;
the initial gypsum precipitation stage consisting of a multi-stage reactor
the initial gypsum precipitation stage being operated at a pH that is greater than pH 7 and less than that which is necessary for the formation of ettringite;
the initial gypsum precipitation stage creating an initial reaction mixture comprising suspended particles suspended within a partially treated aqueous phase, the said mixture including any one or more of dissolved and precipitated aluminium, precipitated metals and precipitated gypsum;
the ettringite production stage producing calcium alumino-sulphate hydrate compounds;
compounds selected from aluminium containing compounds, calcium containing compounds, and hydroxide containing compounds being added to the ettringite production stage;
suspended particles including calcium alumino-sulphate hydrate compounds and other aluminium containing compounds within the product from the ettringite production stage, being separated within the first particle removal stage and returned to the initial gypsum precipitation stage and being used within the initial gypsum precipitation stage to precipitate layered double hydroxide compounds, hydrated hydroxide-based compounds and any one or more of compounds containing metals, sulphate and/or phosphate; and
adjunct reagents, including compounds selected from dolomite, limestone, dolomitic lime, lime, other hydroxide containing compounds, sulphuric acid and other acidic compounds, in any combination, being optionally added to the initial gypsum precipitation stage,
Characterized in that;
initial reaction mixture from the initial gypsum precipitation stage being directed to the second particle segregation stage;
the first and second particle segregation stages comprising assemblies of one or more devices which are selected, sized and arranged so that differences between particle settling velocities of the suspended particles within the partially treated aqueous phase are used to segregate those suspended particles into a first group of particles and a second group of particles;
the first group of particles being characterized by having a similar or lower average settling velocity within the partially treated aqueous phase relative to the average settling velocity within the partially treated aqueous phase of particles of aluminium containing compounds that are precipitated within the initial gypsum precipitation stage thereby causing the first group of particles to be rich in slower settling suspended particles of aluminium containing compounds that are precipitated within the initial gypsum precipitation stage and depleted in more rapidly settling suspended particles of gypsum that are precipitated within the initial gypsum precipitation stage;
the second group of particles being characterised by having a higher average particle settling velocity within the partially treated aqueous phase relative to the average settling velocity within the partially treated aqueous phase of particles of aluminium containing compounds that are precipitated within the initial precipitation stage thereby causing the second group of particles to be rich in the more rapidly settling suspended particles of gypsum that are precipitated within the initial gypsum precipitation stage and depleted in the slower settling suspended particles of aluminium containing compounds that are precipitated within the initial gypsum precipitation stage;
the second group of particles being forwarded to an underflow product in admixture with a portion of the partially treated aqueous phase that is fed to that particle segregation stage wherein the size of that portion of the aqueous phase is selected and arranged so as to maintain satisfactory operation within that particle segregation stage;
the first group of particles in admixture with a remainder of the partially treated aqueous phase that is fed to that particle segregation stage being forwarded to an overhead product;
the overhead product from the first particle segregation stage being forwarded to the ettringite production stage;
the underflow product from the first particle segregation stage being returned to the same stage within the multi-stage reactor as where stream enters;
the overhead product from the second particle segregation stage being returned to the same stage within the multi-stage reactor as the offtake for stream is located;
the input to the first particle segregation stage being made up partly from the initial reaction stage and mostly from the overhead product from the second particle segregation stage or, preferably, entirely from the overhead product.
underflow product from the second particle segregation stage becoming a process residue;

2. (canceled)

3. The process of claim 1, wherein the assemblies of one or more devices using differences between particle settling velocities within suspended particles to segregate those suspended particles into a first group of particles and a second group of particles include devices selected from hydrocyclones, centrifuges, gravity separation and screw classification.

4. The process of claim 1, wherein the first and/or second particle segregation stage/s further include/s a washing process.

5. The process of claim 1, wherein the first and/or second particle segregation stage/s further include/s a leaching process.

6. The process of claim 1, wherein a portion of the second group of particles from the second particle segregation stage is subject to a washing or leaching process using a portion of the high sulphate feed water.

7. (canceled)

8. The process of claim 6, wherein, following the first particle removal stage, the process further sequentially includes a neutralization stage and a second particle removal stage wherein the pH of a particle depleted water that is created within the first particle removal stage is reduced by a neutralizing agent within the neutralization stage to produce a neutralized water and precipitated solids, the precipitated solids being created within the neutralization stage and separated within the second particle removal stage.

9. The process of claim 8, wherein precipitated solids created within the neutralization stage are returned to an earlier stage in the process.

10. The process of claim 8, wherein the neutralizing agent used within the neutralization stage is selected from carbon dioxide, bicarbonate and carbonate containing compounds.

11. The process of claim 1, wherein the high sulphate feed water is a mine waste water.

12. A water product produced by the process of claim 9 which has a reduced sulphate content relative to that of the high sulphate feed water.

13. (canceled)
